(19) United States
(12) Patent Application Publication
(10) Pub. No.: US 2025/0317877 A1
(43) Pub. Date: Oct. 9, 2025

(54) ON-DEMAND SYSTEM INFORMATION BLOCK 1 (SIB1) REQUEST

(71) Applicant: Lenovo (United States) Inc., Morrisville, NC (US)

(72) Inventors: Prateek Basu Mallick, Dreieich (DE); Alexander Golitschek Edler von Elbwart, Darmstadt (DE); Joachim Löhr, Wiesbaden (DE)

(73) Assignee: Lenovo (United States) Inc., Morrisville, NC (US)

(21) Appl. No.: 18/647,835

(22) Filed: Apr. 26, 2024

Related U.S. Application Data
(60) Provisional application No. 63/574,197, filed on Apr. 3, 2024.
(60) Provisional application No. 63/574,199, filed on Apr. 3, 2024.

(51) Int. Cl. H04W 56/00; H04W 72/1273; H04W 74/0833

(52) U.S. Cl. CPC H04W 56/0015; H04W 72/1273; H04W 74/0833

(57) ABSTRACT

Various aspects of the present disclosure relate to on-demand system information block 1 (SIB1) request. An apparatus, such as a UE, receives synchronization signal block (SSB). The apparatus transmits a SIB1 request based at least in part on the SSB including one or more of a cell identifier configured for on-demand SIB1 transmission, a first parameter configured for on-demand SIB1 request, or a second parameter configured for on-demand SIB1 request.

### RELATED APPLICATIONS

This application claims priority to U.S. Provisional Application Ser. No. 63/574,197 filed Apr. 3, 2024 entitled “RESOURCES FOR ON-DEMAND SYSTEM INFORMATION BLOCK 1 (SIB1) REQUESTS,” the disclosure of which is incorporated by reference herein in its entirety. This application also claims priority to U.S. Provisional Application Ser. No. 63/574,199 filed Apr. 3, 2024 entitled “SYNCHRONIZATION SIGNAL BLOCK (SSB) FOR ON-DEMAND SYSTEM INFORMATION BLOCK 1 (SIB1) REQUESTS,” the disclosure of which is incorporated by reference herein in its entirety.

### TECHNICAL FIELD

The present disclosure relates to wireless communications, and more specifically to power conservation in wireless communications systems.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive synchronization signal block (SSB); and transmit a system information block 1 (SIB1) request based at least in part on the SSB including one or more of a cell identifier configured for on-demand SIB1 transmission, a first parameter configured for on-demand SIB1 request, or a second parameter configured for on-demand SIB1 request.

In some implementations of the method and apparatuses for a UE described herein, the cell identifier includes a physical cell identifier (PCID); the first parameter includes a frequency domain offset between the SSB and a resource block grid in numbers of subcarriers, and wherein at least one processor is configured to cause the UE to determine, if a value for the first parameter is greater than a specified value, that the first parameter is to be determined via a physical broadcast channel (PBCH) field; the second parameter includes physical downlink control channel (PDCCH) configuration for receiving SIB1, and the second parameter includes common control resource set (CORESET) information, a common search space, and one or more PDCCH parameters; the first parameter includes at least one of: one or more first parameter values for a first frequency range; or one or more second parameter values for a second frequency range; the SSB further includes an indication of one or more physical random access channel (PRACH) resources for transmission of for the SIB1 request, and wherein the at least one processor is configured to cause the UE to transmit the SIB1 request on at least one PRACH resource of the one or more PRACH resources; the at least one processor is configured to cause the UE to: determine at least one index value using a combination of the cell identifier, the first parameter, and the second parameter; and determine the at least one resource based at least in part on the index value.

In some implementations of the method and apparatuses for a UE described herein, the at least one processor is configured to cause the UE to attempt, after transmission of the SIB request, to receive broadcasted SIB1; the at least one processor is configured to cause the UE to one or more of: attempt to receive the broadcasted SIB1 immediately after transmission of the SIB1 request; or attempt to receive the broadcasted SIB1 after a first time duration after transmission of the SIB1 request; the at least one processor is configured to cause the UE to retransmit the SIB1 request based at least in part on not receiving SIB1 after a second time duration; the SSB includes a master information block (MIB), and wherein the at least one processor is configured to cause the UE to: determine that the MIB includes an indication that cell access is barred; and transmit the SIB1 request based at least in part on the cell identifier configured for on-demand SIB1 transmission, the first parameter configured for on-demand SIB1 request, the second parameter configured for on-demand SIB1 request, and the MIB indicating that cell access is barred; the at least one processor is configured to cause the UE to receive SIB1, the SIB1 including remaining minimum system information (RMSI).

Some implementations of the method and apparatuses described herein may further include a processor for wireless communication to receive SSB; and transmit a SIB1 request based at least in part on the SSB including one or more of a cell identifier configured for on-demand SIB1 transmission, a first parameter configured for on-demand SIB1 request, or a second parameter configured for on-demand SIB1 request.

In some implementations of the method and apparatuses for a processor described herein, the first parameter includes a frequency domain offset between the SSB and a resource block grid in numbers of subcarriers, and wherein the at least one controller is configured to cause the processor to determine, if a value for the first parameter is greater than a specified value, that the first parameter is to be determined via a PBCH field; the second parameter includes PDCCH configuration for receiving SIB1, and the second parameter includes common CORESET information, a common search space, and one or more PDCCH parameters; the at least one controller is configured to cause the processor to one or more of: attempt to receive broadcasted SIB1 immediately after transmission of the SIB1 request; or attempt to receive the broadcasted SIB1 after a first time duration after transmission of the SIB1 request.

In some implementations of the method and apparatuses for a processor described herein, the cell identifier includes a PCID; the first parameter includes a frequency domain offset between the SSB and a resource block grid in numbers of subcarriers, and at least one controller is configured to cause the processor to determine, if a value for the first parameter is greater than a specified value, that the first parameter is to be determined via a PBCH field; the second parameter includes PDCCH configuration for receiving SIB1, and the second parameter includes common CORESET information, a common search space, and one or more PDCCH parameters; the first parameter includes at least one of: one or more first parameter values for a first frequency range; or one or more second parameter values for a second frequency range; the SSB further includes an indication of one or more PRACH resources for transmission of for the SIB1 request, and at least one controller is configured to cause the processor to transmit the SIB1 request on at least one PRACH resource of the one or more PRACH resources; the at least one processor is configured to cause the UE to: determine at least one index value using a combination of the cell identifier, the first parameter, and the second parameter; and determine the at least one resource based at least in part on the index value.

In some implementations of the method and apparatuses for a processor described herein, the at least one controller is configured to cause the processor to attempt, after transmission of the SIB request, to receive broadcasted SIB1; the at least one processor is configured to cause the UE to one or more of: attempt to receive the broadcasted SIB1 immediately after transmission of the SIB1 request; or attempt to receive the broadcasted SIB1 after a first time duration after transmission of the SIB1 request; the at least one controller is configured to cause the processor to retransmit the SIB1 request based at least in part on not receiving SIB1 after a second time duration; the SSB includes a master information block (MIB), and wherein the at least one processor is configured to cause the UE to: determine that the MIB includes an indication that cell access is barred; and transmit the SIB1 request based at least in part on the cell identifier configured for on-demand SIB1 transmission, the first parameter configured for on-demand SIB1 request, the second parameter configured for on-demand SIB1 request, and the MIB indicating that cell access is barred; the at least one controller is configured to cause the processor to receive SIB1, the SIB1 including RMSI.

Some implementations of the method and apparatuses described herein may further include a method performed by a UE, the method including receiving SSB; and transmitting a SIB1 request based at least in part on the SSB including one or more of a cell identifier configured for on-demand SIB1 transmission, a first parameter configured for on-demand SIB1 request, or a second parameter configured for on-demand SIB1 request.

In some implementations of the method and apparatuses for a UE described herein, the cell identifier includes a PCID; the first parameter includes a frequency domain offset between the SSB and a resource block grid in numbers of subcarriers, and wherein the method further includes determining, if a value for the first parameter is greater than a specified value, that the first parameter is to be determined via a PBCH field; the second parameter includes PDCCH configuration for receiving SIB1, and the second parameter includes common CORESET information, a common search space, and one or more PDCCH parameters; the first parameter includes at least one of: one or more first parameter values for a first frequency range; or one or more second parameter values for a second frequency range; the SSB further includes an indication of one or more PRACH resources for transmission of for the SIB1 request, and wherein the method further includes transmitting the SIB1 request on at least one PRACH resource of the one or more PRACH resources; further including: determining at least one index value using a combination of the cell identifier, the first parameter, and the second parameter; and determining the at least one resource based at least in part on the index value.

In some implementations of the method and apparatuses for a UE described herein, the method further including attempting, after transmission of the SIB request, to receive broadcasted SIB1; further including one or more of: attempting to receive the broadcasted SIB1 immediately after transmission of the SIB1 request; or attempting to receive the broadcasted SIB1 after a first time duration after transmission of the SIB1 request; further including retransmitting the SIB1 request based at least in part on not receiving SIB1 after a second time duration; the SSB includes a MIB, and wherein the method further includes: determining that the MIB includes an indication that cell access is barred; and transmitting the SIB1 request based at least in part on the cell identifier configured for on-demand SIB1 transmission, the first parameter configured for on-demand SIB1 request, the second parameter configured for on-demand SIB1 request, and the MIB indicating that cell access is barred; further including receiving SIB1, the SIB1 including RMSI.

Some implementations of the method and apparatuses described herein may further include a network equipment (NE) for wireless communication to transmit SSB including one or more of a cell identifier configured for on-demand SIB1 transmission, a first parameter configured for on-demand SIB1 request, or a second parameter configured for on-demand SIB1 request; receive a SIB1 request; and transmit SIB1 based at least in part on the SIB1 request.

In some implementations of the method and apparatuses for a NE described herein, the cell identifier includes a PCID, the first parameter includes a frequency domain offset between the SSB and a resource block grid in numbers of subcarriers, and the second parameter includes PDCCH configuration for receiving SIB1, and the second parameter including common CORESET information, a common search space, and one or more PDCCH parameters; the at least one processor is configured to cause the NE to transmit an indication of one or more resources for transmission of the SIB1 request, the indication including at least one index value generated using a combination of the cell identifier, the first parameter, and the second parameter.

Some implementations of the method and apparatuses described herein may further include a method performed by a NE, the method including transmitting SSB including one or more of a cell identifier configured for on-demand SIB1 transmission, a first parameter configured for on-demand SIB1 request, or a second parameter configured for on-demand SIB1 request; receiving a SIB1 request; and transmitting SIB1 based at least in part on the SIB1 request.

In some implementations of the method and apparatuses for a NE described herein, the cell identifier includes a PCID, the first parameter includes a frequency domain offset between the SSB and a resource block grid in numbers of subcarriers, and the second parameter includes PDCCH configuration for receiving SIB1, and the second parameter includes common CORESET information, a common search space, and one or more PDCCH parameters; further including transmitting an indication of one or more resources for transmission of the SIB1 request, the indication including at least one index value generated using a combination of the cell identifier, the first parameter, and the second parameter.

### BRIEF DESCRIPTION OF THE DRAWINGS

FIG. 1 illustrates an example of a wireless communications system in accordance with aspects of the present disclosure.

FIG. 2 illustrates a time and frequency structure 200 of an SS/PBCH block.

FIGS. 3 and 4 illustrate an example 300 for the timing of candidate SS/PBCH blocks within the SS burst set.

FIG. 5 illustrates an example procedure 500 for MIB and SIB transmission and relationships among SIBs.

FIG. 6 illustrates a method 600 for acquiring on-demand SIB1 in accordance with aspects of the present disclosure.

FIG. 7 illustrates an example SI-Request-Config IE 700 in accordance with aspects of the present disclosure.

FIG. 8 illustrates an example RACH-ConfigGeneric IE 800 in accordance with aspects of the present disclosure.

FIG. 9 illustrates an example IE 900 in accordance with aspects of the present disclosure.

FIG. 10 illustrates an example of a UE 1000 in accordance with aspects of the present disclosure.

FIG. 11 illustrates an example of a processor 1100 in accordance with aspects of the present disclosure.

FIG. 12 illustrates an example of a NE 1200 in accordance with aspects of the present disclosure.

FIG. 13 illustrates a flowchart of a method 1300 in accordance with aspects of the present disclosure.

FIG. 14 illustrates a flowchart of a method 1400 in accordance with aspects of the present disclosure.

### DETAILED DESCRIPTION

In a wireless communications system, a UE and a NE (e.g., a base station) may support wireless communication (e.g., reception and/or transmission of wireless communication) using time-frequency resources. To enable a UE to connect to a NE for wireless communication, the UE may attempt to acquire (e.g., receive, obtain, retrieve, etc.) time and frequency synchronization with the NE and detect a PCID of the NE. To enable UE to obtain time/frequency synchronization with the NE, the NE may communicate (e.g., transmit, send, etc.) synchronization signals such as SSBs that include synchronization components, e.g., primary synchronization signal (PSS), secondary synchronization signal (SSS), MIB, PBCH, PCID, etc. The UE may receive the SSBs to obtain information for acquiring access and connectivity to the NE.

For instance, the NE can transmit SIB1 (e.g., as a radio resource control (RRC) message over downlink shared channel (DL-SCH)) and the UE can receive the SIB1 and decode the SIB1 using information from the MIB included in the SSB. SIB1 can include various information such as the availability and scheduling of other SIB as well as RRC information. In implementations SIB1 represents RMSI and differs from other system information, such as system information included in other SIBs, e.g., SIB2, SIB3, . . . . SIBN, etc. A NE, however, can expend substantial energy resources in transmitting the different signaling including SSBs, PBCH, MIB, and SIB1. For instance, an NE can broadcast SIB1 with a periodicity (e.g., every n milliseconds (ms)) which can contribute significantly to energy usage of a wireless communications system.

Accordingly, the present disclosure describes techniques for a UE to determine whether SIB1 transmission by a NE is available on-demand as well as for a UE to determine resources (e.g., PRACH resources) for requesting on-demand SIB1 transmission from a NE. For instance, availability of SIB1 on-demand request can be determined in different ways such as via use of custom PCIDs, one or more parameters configured for an on-demand SIB1 request, failure to receive SIB1 after a threshold timer and/or threshold number of SIB1 acquisition attempts, cell barring (e.g., in MIB), subcarrier offset indicating that SIB1 is not broadcasted (e.g., is to be requested on-demand), and/or a value determined from SSB and/or MIB. Based on a determination of whether on-demand SIB transmission is available, a UE can determine whether to attempt to detect broadcasted SIB1 and/or to request on-demand SIB1 transmission.

Further, SIB1 request resources (e.g., PRACH resources, time/frequency resources, etc.) for requesting on-demand SIB1 transmission can be determined in various ways. For instance, a UE can determine request resources as a function of resources on which SSB transmission is received. Request resources, for example, can be determined as combinations of MIB and/or PBCH bits to determine a frequency offset for determining resources for a PRACH transmission requesting SIB1. Alternatively or additionally, a PRACH occasion for requesting SIB1 can be determined as a function of PCID and/or of MIB or PBCH content. Thus, implementations can enable a NE to refrain from broadcasting SIB1 (e.g., periodically) and respond to on-demand requests for SIB1 transmission using targeted SIB1 transmission.

By utilizing the described techniques, power resource conservation can be realized from both the NE and UE perspectives. For instance, a NE can refrain from periodic SIB1 broadcasting and can respond to on-demand SIB1 requests via triggered SIB1 transmission. Further, a UE can minimize SIB1 detection processes and implement on-demand SIB1 requests to an NE.

Aspects of the present disclosure are described in the context of a wireless communications system.

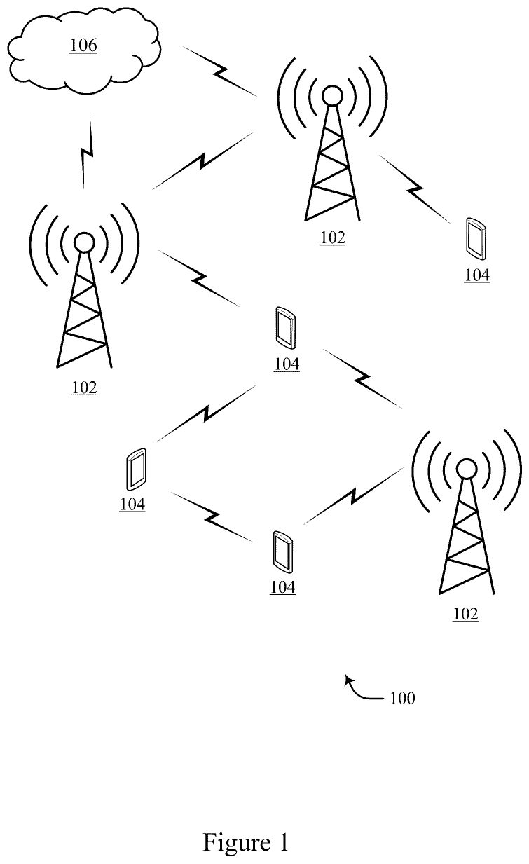

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, fifth, sixth, and seventh numerologies (i.e., μ=0, μ=1, μ=2, μ=3, μ=4, μ=5, μ=6) associated with respective subcarrier spacings of 15 kHz, 30 kHz, 60 kHz, 120 kHz, 240 kHz, 480 kHz, and 960 kHz may utilize a single slot per subframe, two slots per subframe, four slots per subframe, eight slots per subframe, 16 slots per subframe, 32 slots per subframe, and 64 slots per subframe respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as in frequency range designations frequency range 1 (FR1) (410 MHz-7.125 GHz), frequency range 2 (FR2) (24.25 GHZ-71 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station) can transmit signaling (e.g., SSB) indicating whether the NE 102 supports on-demand SIB1 transmission. A UE 104 can receive the signaling and determine whether to perform an on-demand SIB1 request. Upon determination that on-demand SIB1 transmission is available, the UE 104 can determine request resources for transmitting an on-demand SIB1 request. The request resources, for instance, can be determined as a function of resources on which SSB transmission is received and/or as a function of PCID and/or of MIB or PBCH content. The UE 104 can request SIB1 transmission and the NE 102 can transmit SIB1 to enable the UE 104 to obtain connectivity to the NE 102 for wireless communication.

Emissions and energy consumption from different elements of a telecommunication system is adversely contributing to the climate. Further, the operating expenses to run telecommunication services are significant. In wireless communications system, a number of industry-specific factors rooted in countering rising network costs have shaped efficiency efforts. A continued rise in mobile data traffic is occurring, estimated at 6.4 gigabytes (GB) per user per month in 2019 and forecast to grow threefold on a per-user basis over the following five years. Combined with the rising costs of spectrum, capital investment, and ongoing RAN maintenance/upgrades, energy-saving measures in network operations are important. 5G New Radio (NR) offers a significant energy-efficiency improvement per gigabyte over previous generations of mobility. However, 5G use cases and the adoption of mm Wave will require more sites and antennas. This leads to the prospect of a more efficient network that could paradoxically result in higher emissions.

A study on network energy saving in NR justifies the need for energy saving [3GPP Technical Report (TR) 38.864]. This study indicates that network energy saving is of great importance for environmental sustainability, to reduce environmental impact (greenhouse gas emissions), and for operational cost savings. As 5G is becoming pervasive across industries and geographical areas involving handling more advanced services and applications requiring very high data rates (e.g., for extended reality (XR)), networks are becoming denser, using more antennas, larger bandwidths, and more frequency bands.

Energy consumption has become a key part of operators' operating expenses. According to some estimates, the energy cost on mobile networks accounts for ˜23% of the total operator cost. Most of the energy consumption comes from the radio access network and in particular from the Active Antenna Unit (AAU), with data centers and fiber transport accounting for a smaller share. The power consumption of a radio access can be split into two parts: the dynamic part which is only consumed when data transmission/reception is ongoing, and the static part which is constantly consumed to maintain the necessary operation of the radio access devices, even when the data transmission/reception is not on-going.

Therefore, there was a need to study and develop a network energy consumption model especially for the base station (a UE power consumption model was already defined in TR38.840), KPIs, and an evaluation methodology and to identify and study network energy savings techniques in targeted deployment scenarios. The study investigated how to achieve more efficient operation dynamically and/or semi-statically and finer granularity adaptation of transmissions and/or receptions in one or more of network energy saving techniques in time, frequency, spatial, and power domains, with potential support/feedback from UE, potential UE assistance information, and information exchange/coordination over network interfaces.

The study not only evaluated the potential network energy consumption gains, but also assessed and balanced the impact on network and user performance, e.g., by looking at KPIs such as spectral efficiency, capacity, user perceived throughput (UPT), latency, UE power consumption, complexity, handover performance, call drop rate, initial access performance, Service Level Agreement (SLA) assurance related KPIs, etc.

UEs can transmit PRACH to enable UE connectivity to the NEs. PRACH in 5G involves preamble transmission where a UE selects a random access preamble from a set of predefined preambles. These preambles can be of approximately two categories: Short Preamble and Long Preamble Format. The UE also selects a random sequence number for the preamble. After choosing the preamble and sequence number, the UE transmits the preamble on the PRACH.

Regarding Synchronization Signal/PBCH block (SS/PBCH block), cell search is the procedure for a UE to acquire time and frequency synchronization with a cell and to detect PCID of the cell. During cell search operations which are carried out when a UE is powered ON, mobility in connected mode, idle mode mobility (e.g. reselections), inter-RAT mobility to NR system etc., the UE uses NR synchronization signals and PBCH to derive the necessary information to access the cell. Similar to LTE, two types of synchronization signals are defined for NR: PSS and SSS. The Synchronization Signal/PBCH block (SS/PBCH block; also known as SSB) consists of PSS, SSS and Physical Broadcast Channel (PBCH). Synchronization signals can also be used by the UE for Reference Signal Received Power (RSRP) and Reference Signal Received Quality (RSRQ) measurements.

Regarding PCID, there are 1008 unique PCIDs defined in 5G NR and the 1008 NR PCIDs are divided into 336 unique groups, with each group consisting of three different identities. A PCID of a cell can be calculated using:

$${N}_{ID}^{Cell} = 3 * {N}_{ID}^{( 1 )} + {N}_{ID}^{( 2 )} where {N}_{ID}^{( 1 )} ∈ \{ 0 , 1 , … , 335 \} and {N}_{ID}^{( 2 )} ∈ \{ 0 , 1 , 2 \}$$

The UE can derive PCI group number N_{ID}⁽¹⁾ from SSS and physical-layer identity N_{ID}⁽²⁾ from PSS.

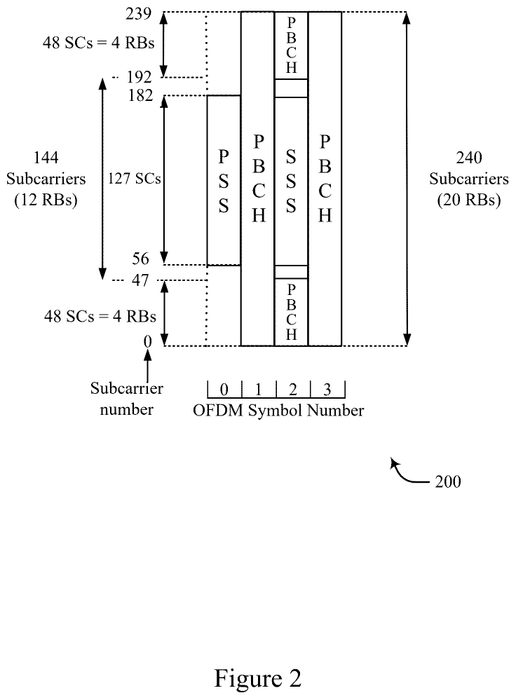

FIG. 2 illustrates a time and frequency structure 200 of an SS/PBCH block. In the time and frequency structure 200, PSS, SSS and PBCH are together in consecutive OFDM symbols and each SS/PBCH block occupies 4 OFDM symbols in the time domain and spread over 240 subcarriers (20 RBs) in the frequency domain. Further, PSS occupies the first OFDM symbol and span over 127 subcarriers, and SSS is located in the third OFDM symbol and span over 127 subcarriers. There are 8 unused subcarriers below SSS and 9 unused subcarriers above SSS. PBCH occupies two full OFDM symbols (second and fourth) spanning 240 subcarriers and in the third OFDM symbol spanning 48 subcarriers below and above SSS. This results in PBCH occupying 576 subcarriers across three OFDM symbols (240+48+48+240=576). PBCH demodulation reference signal (DM-RS) occupies 144 REs which is one-fourth of total REs and remaining for PBCH payload (576−144=432 REs).

Table 1 presents a summary of frequency resources occupied by SS/PBCH block, including PSS, SSS, PBCH and DM-RS for PBCH. The complex-valued symbols corresponding to resource elements denoted as ‘Set to 0’ in Table 1 are set to zero. As can be seen from Table 1, the location of PBCH DM-RS depends upon PCID (v=N_{ID}^{cell} mod 4) of the cell, e.g., PCID already determined by the UE using PSS/SSS.

TABLE 1

| | OFDM symbol number ‘l’ | |
|---|---|---|
| Channel or | relative to the start of an | Subcarrier number ‘k’ |
| Signal | SS/PBCH block | relative to the start of an SS/PBCH block |
| PSS | 0 | 56, 57, . . . , 182 |
| SSS | 2 | 56, 57, . . . , 182 |
| Set to ‘0’ | 0 | 0, 1, . . . , 55, 183, 184, . . . , 239 |
| | 2 | 48, 49, . . . , 55, 183, 184, . . . , 191 |
| PBCH | 1, 3 | 0, 1, . . . , 239 |
| | 2 | 0, 1, . . . , 47, |
| | | 192, 193, . . . , 239 |
| DM-RS for | 1, 3 | 0 + v, 4 + v, 8 + v, . . . , 236 + v |
| PBCH | 2 | 0 + v, 4 + v, 8 + v, . . . , 236 + v |
| | | 192 + v, 196 + v, . . . , 236 + v |

Regarding SSB details in time domain, each SS/PBCH block spans across 4 OFDM symbols in the time domain and an SS/PBCH block is periodically transmitted with a periodicity of 5 ms, 10 ms, 20 ms, 40 ms, 80 ms or 160 ms. While longer SS/PBCH block periodicities enhances network energy performance, the shorter periodicities facilitate faster cell search for UEs. A UE can assume a default periodicity of 20 ms during initial cell search or idle mode mobility.

Regarding a SS burst set, to enable beam-sweeping for PSS/SSS and PBCH, SS burst sets are defined. An SS burst set includes a set of SS/PBCH block, and each SS/PBCH block can be transmitted on a different beam. Further, a SS burst set can include one or more SS/PBCH blocks. SS/PBCH blocks in the SS burst set are transmitted in time-division multiplexing fashion and an SS burst set can be confined to a 5 ms window and is either located in a first half or in a second half of a 10 ms radio frame. The network sets the SS/PBCH block periodicity via RRC parameter ssb-PeriodicityServingCell which can take values in the range {5 ms, 10 ms, 20 ms, 40 ms, 80 ms, 160 ms}. The maximum number of candidate SS/PBCH blocks (Lₘₐₓ) within an SS burst set depends upon the carrier frequency/band such as shown in Table 2 below.

TABLE 2

| | Max. No. of Candidate SS/PBCH blocks |
|---|---|
| Carrier Frequency | within SS Burst Set (Lₘₐₓ) |
| f_{c} ≤ 3 GHz* | 4 |
| 3 GHz* < f_{c} ≤ 6 GHz | 8 |
| f_{c} > 6 GHz | 64 |

*SCS = 30 kHz case: for paired spectrum, 3 GHz, for unpaired spectrum, 2.4 GHz is used

Within a 5 ms half frame, the starting OFDM symbol index for a candidate SS/PBCH block within SS burst set depends upon subcarrier spacing (SCS) and carrier frequency/band summarized in Table 3 below. See section 4.1 from 3GPP Technical Specification (TS) 38.213 for full details.

TABLE 3

| | OFDM starting | f_{c} ≤ 3 | 3 GHz* < f_{c} ≤ 6 | |
|---|---|---|---|---|
| | symbols of the | GHz* | GHz | f_{c} > 6 GHz |
| SCS | candidate SSBs | Lₘₐₓ = 4 | Lₘₐₓ = 8 | Lₘₐₓ = 4 |
| CaseA: | {2, 8} + 14n | n = 0, 1 | n = 0, 1, 2, 3 | NA |
| 15 | | {2, 8, 16, 22} | {2, 8, 16, 22, 30, 36, | |
| kHz | | | 44, 50} | |
| CaseB: | {4, 8, 16, 20} + 28n | n = 0 | n = 0, 1 | NA |
| 30 | | {4, 8, 16, 20} | {4, 8, 16, 20, 32, 36, | |
| kHz | | | 44, 48} | |
| CaseC: | {2, 8} + 14n | n = 0, 1 | n = 0, 1, 2, 3 | NA |
| 30 | | {2, 8, 16, 22} | {2, 8, 16, 22, 30, 36, | |
| kHz | | | 44, 50} | |
| CaseD: | {4, 8, 16, 20} + 28n | NA | NA | n = 0, 1, 2, 3, 5, 6, 7, 8, 10, 11, 12, 13, 15, |
| 120 | | | | 16, 17, 18 |
| kHz | | | | {4, 8, 16, 20 . . . 508, 512, 520, 524} |
| CaseE: | {8, 12, 16, 20, 32, 36, | NA | NA | n = 0, 1, 2, 3, 5, 6, 7, 8 |
| 240 | 40, 44} + 56n | | | {8, 12, 16, 20 . . . |
| kHz | | | | 480, 484, 488, 492} |

*SCS = 30 kHz case: for paired spectrum, 3 GHz, for unpaired spectrum, 2.4 GHz is used
Entries within curly brackets denote OFDM starting symbols for the candidate SS/PBCH blocks

Note that when the network is not using beam forming, it may transmit only one SS/PBCH block and hence there can only be one SS/PBCH block starting position.

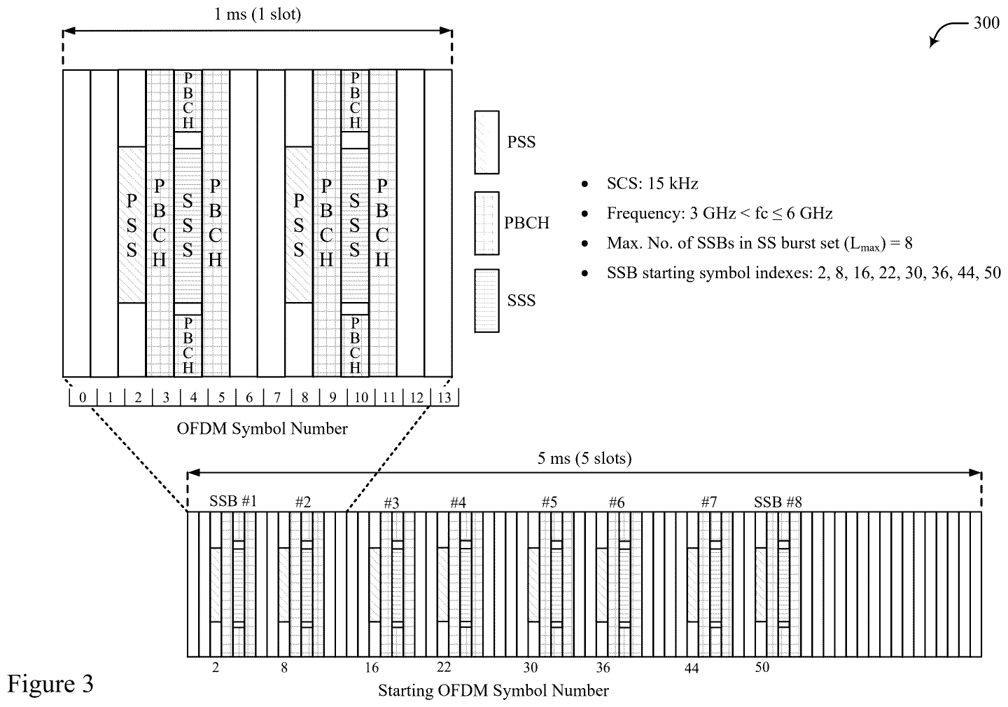

FIGS. 3 and 4 illustrate an example 300 for the timing of candidate SS/PBCH blocks within the SS burst set. The example 300, for instance, is for the case of SCS=15 kHz and carrier frequency between 3 GHz and 6 GHz.

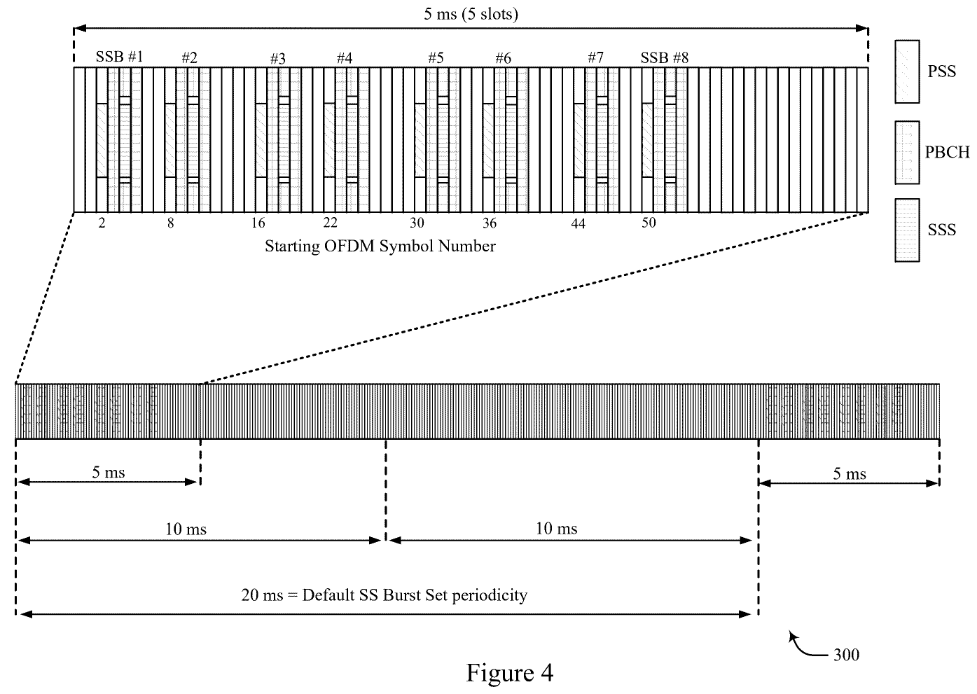

FIG. 5 illustrates an example procedure 500 for MIB and SIB transmission and relationships among SIBs. The procedure 500, for instance, illustrates communication between a NE 102 and a UE 104.

The following represents some characteristics of MIB. See TS 38.331-5.2.1 and TS 38.213-4.1 for further details of MIB scheduling. MIB can be transmitted over broadcast channel (BCH)/PBCH. PBCH is transmitted as a part of SSB. MIB can be transmitted with the periodicity of 80 ms and within this 80 ms repetitive transmission can occur. For initial cell selection, a UE may assume that half frames with SS/PBCH blocks occur with a periodicity of 2 frames. MIB can include the parameters that are required to decode SIB1.

The following represents an example implementation of an MIB:

| MIB ::= SEQUENCE { | |
|---|---|
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | INTEGER (0..255), |
| cellBarred | ENUMERATED {barred, notBarred}, |
| intraFreqReselection | ENUMERATED {allowed, notAllowed}, |
| spare | BIT STRING (SIZE (1)) |

The field subCarrierSpacingCommon indicates the Subcarrier spacing for SIB1, Msg.2/4 for initial access and system information (SI)-messages. Interpretation of this value varies with frequency range as summarized in Table 4.

TABLE 4

| | scs15or60 | scs30or120 |
|---|---|---|
| FR1 | 15 Khz | 30 Khz |
| FR2 | 60 Khz | 120 Khz |

The field ssb-subcarrierOffset corresponds to k_{ssb} (see, e.g., TS 38.213). This field indicates the frequency domain offset between SSB and the overall resource block grid in number of subcarriers. If k_ssb requires the value higher than 15, it is represented by the combination of a PBCH data field and ssb-subcarrierOffset. The field dmrs-TypeA-Position indicates position of (first) downlink (DL) DM-RS. The field pdcchConfigSIB1 determines a bandwidth for PDCCH/SIB, a common ControlResourceSet (CORESET), a common search space, and necessary PDCCH parameters. This corresponds to RMSI-PDCCH-Config.

The following represent characteristics of SIB1 such as in 5G implementations. SIB1 can be transmitted over DL-SCH (NOTE: SIB1 is the first RRC message except MIB). SIB1 can be transmitted with the periodicity of 160 ms and within this 160 ms repetitive transmission can occur. SIB1 includes information regarding the availability and scheduling (e.g. periodicity, SI-window size) of other SIB. SIB1 indicates whether other SIBs are provided via periodic broadcast basis or only on-demand basis. If other SIBs than SIB1 are provided on-demand the SIB1 can include information for the UE to perform SI request.

Accordingly, implementations described herein provide solutions for enabling on-demand request and transmission of SIB1, such as to realize energy savings on both the network and UE side. For instance, the described techniques provide ways for determining whether on-demand SIB1 is available and for identifying resources for requesting on-demand SIB1 transmission.

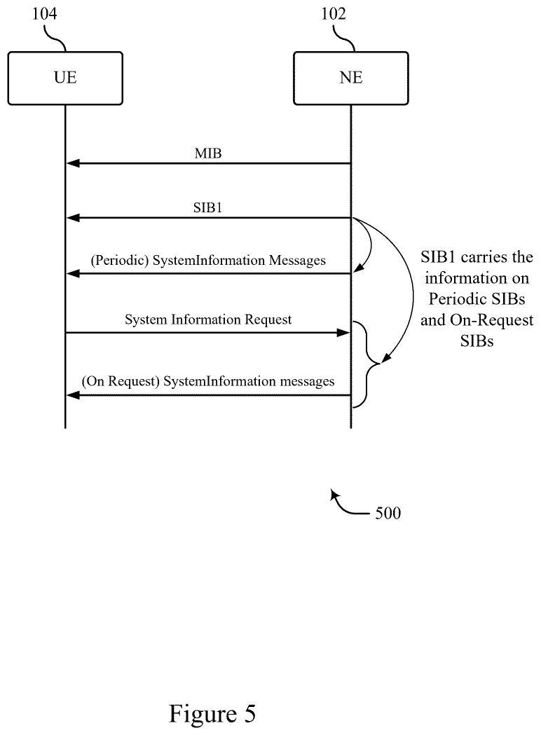

FIG. 6 illustrates a method 600 for acquiring on-demand SIB1 in accordance with aspects of the present disclosure. The method 600, for instance, represents an overview of the implementations described in the present disclosure, such as implementations detailed below. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

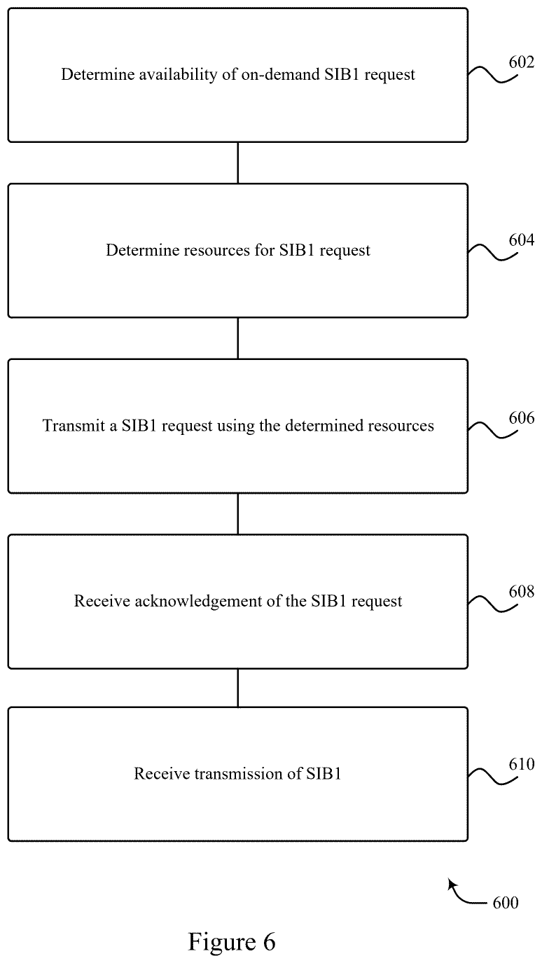

At 602, the method may include determining availability of on-demand SIB1 request. The operations of 602 may be performed in accordance with examples as described herein. In some implementations, aspects of the operations of 602 may be performed by a UE as described with reference to FIG. 7.

At 604, the method may include determining resources for SIB1 request. The operations of 604 may be performed in accordance with examples as described herein. In some implementations, aspects of the operations of 604 may be performed by a UE as described with reference to FIG. 7.

At 606, the method may include transmitting a SIB1 request using the determined resources. The operations of 606 may be performed in accordance with examples as described herein. In some implementations, aspects of the operations of 606 may be performed a UE as described with reference to FIG. 7.

At 608, the method may include receiving acknowledgement of the SIB1 request. The operations of 608 may be performed in accordance with examples as described herein. In some implementations, aspects of the operations of 608 may be performed a UE as described with reference to FIG. 7.

At 610, the method may include receiving transmission of SIB1. The operations of 610 may be performed in accordance with examples as described herein. In some implementations, aspects of the operations of 610 may be performed a UE as described with reference to FIG. 7.

In implementations, a UE determines from SSB a PCID of a cell. The SSB, for instance, includes components such as PSS, SSS, PBCH including MIB, etc. In at least one example the PCID can be determined from detected PSS and/or SSS sequence IDs. PCIDs and/or a PCID range can be predetermined to enable a UE to transmit on-demand SIB1 transmission request on the cell. For example, PCID Mode ‘N’ may be used to determine custom PCIDs configured to signal the availability of on-demand SIB1 transmission. In an example, if N=100, then PCIDs 100, 200, 300 . . . 1000 represent the custom PCIDs. In another example to use and determine PCIDs as custom PCID, the custom PCID can be associated with a PSS sequence identifier (ID). In NR, for instance, the PSS sequence ID can be {0, 1, 2}. For example, if a UE detects the PSS sequence ID is 2, then the UE is allowed to transmit on-demand SIB1 transmission requests on the cell. The PCIDs and/or determination of PCIDs, including parameters used for such determination, can be specified.

In implementations when a UE determines a cell to have a custom PCID it can initiate on-demand SIB1 request. The request may be implemented by initiating a PRACH procedure where the PRACH resources (e.g., preamble and/or time-frequency resources) may be reserved for on-demand SIB1 requests. Alternatively or additionally, the request may be implemented by initiating a contention based PRACH (CBRA) procedure and later the received grant in Msg2 to transmit a RRC Request or a new medium access control (MAC) control element (CE) to request SIB1 of the current cell.

In implementations, a UE upon determining the custom PCID can first attempt to acquire SIB1 as in legacy scenarios, e.g., to acquire SIB1 from a cell that regularly transmits (e.g., broadcasts) SIB1. After failing to receive SIB1 after ‘t’ ms and/or for ‘a’ number of attempts, the UE can be allowed to request SIB1 on on-demand basis. The parameters ‘t’ ms and/or ‘a’ number of attempts may be specified to have certain default value, can be configured and stored from a previous cell (e.g., in same RAN area), and/or can be configured and stored from the SIB1 of the same cell received previously.

Implementations can also be used to allow an operator (e.g., an operator of a wireless communications system that configures NEs) to use the custom PCIDs as normal PCIDs and allow another operator to use these as custom PCIDs enabling the UEs to request SIB1 on on-demand basis.

In implementations an operator when intending to use the custom PCIDs to enable UEs to request SIB1 on on-demand basis can set the cellBarred information element (IE) included in the MIB to “barred”. Example MIB content is shown below:

| MIB ::= SEQUENCE { | |
|---|---|
| systemFrameNumber BIT STRING (SIZE (6)), | |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

Table 5 below provides some example MIB field descriptions.

TABLE 5
MIB field descriptions

cellBarred
Value barred means that the cell is barred, as defined in TS 38.304. This field is ignored by
Integrated Access and Backhaul Mobile Termination (IAB-MT) and Network Controlled
Repeater MT (NCR-MT). This field is ignored for connectivity to NTN or air-to-ground (ATG).
dmrs-TypeA-Position
Position of (first) DM-RS for downlink (see TS 38.211, clause 7.4.1.1.2) and uplink (see TS
38.211, clause 6.4.1.1.3).
intraFreqReselection
Controls cell selection/reselection to intra-frequency cells when the highest ranked cell is barred,
or treated as barred by the UE, as specified in TS 38.304. This field is ignored by IAB-MT and
NCR-MT.
pdcch-ConfigSIB1
Determines a common ControlResourceSet (CORESET), a common search space and necessary
PDCCH parameters. If the field ssb-SubcarrierOffset indicates that SIB1 is absent, the field
pdcch-ConfigSIB1 indicates the frequency positions where the UE may find SS/PBCH block with
SIB1 or the frequency range where the network does not provide SS/PBCH block with SIB1 (see
TS 38.213, clause 13).
ssb-SubcarrierOffset
Corresponds to k_{SSB} (see TS 38.213), which is the frequency domain offset between SSB and the
overall resource block grid in number of subcarriers. (See TS 38.211, clause 7.4.3.1). For
operation with shared spectrum channel access in FR1 (see 37.213), this field corresponds to
k_{SSB}, and k_{SSB} is obtained from (see TS 38.211, clause 7.4.3.1); the least significant bit (LSB) of
this field is used also for deriving the quasi co-located (QCL) relation between SS/PBCH blocks
as specified in TS 38.213, clause 4.1.
The value range of this field may be extended by an additional most significant bit encoded
within PBCH as specified in TS 38.213.
This field may indicate that this cell does not provide SIB1 and that there is hence no
CORESET#0 configured in MIB (see TS 38.213, clause 13). In this case, the field pdcch-
ConfigSIB1 may indicate the frequency positions where the UE may (not) find a SS/PBCH with a
control resource set and search space for SIB1 (see TS 38.213, clause 13).
subCarrierSpacingCommon
Subcarrier spacing for SIB1, Msg. 2/4 and MsgB for initial access, paging and broadcast SI-
messages. If the UE acquires this MIB on an FR1 carrier frequency, the value scs15or60
corresponds to 15 kHz and the value scs30or120 corresponds to 30 kHz. If the UE acquires this
MIB on an FR2 carrier frequency, the value scs15or60 corresponds to 60 kHz and the value
scs30or120 corresponds to 120 kHz. For operation with shared spectrum channel access in FR1
(see 37.213) and for operation in FR2-2, the subcarrier spacing for SIB1, Msg. 2/4 and MsgB for
initial access, paging and broadcast SI-messages is same as that for the corresponding SSB. For
operation with shared spectrum channel access, this field instead is used for deriving the QCL
relation between SS/PBCH blocks as specified in TS 38.213, clause 4.1.
systemFrameNumber
The 6 most significant bits (MSB) of the 10-bit System Frame Number (SFN). The 4 LSB of the
SFN are conveyed in the PBCH transport block as part of channel coding (i.e. outside the MIB
encoding), as defined in clause 7.1 in TS 38.212.

In implementations SIB1 on-demand capable UEs detecting the custom PCIDs and that the cellBarred IE included in the MIB is set to “barred”, can proceed with requesting SIB1 on an on-demand basis. UEs not configured for requesting on-demand SIB1 may consider the cell as barred. An operator that regularly transmits (e.g., broadcasts) SIB1 may continue to use custom PCIDs as normal PCIDs and set the cellBarred IE included in the MIB to “notBarred”.

In some scenarios an operator may continue to use custom PCIDs as normal PCIDs but is to bar a cell for specific reasons (e.g., cell maintenance) and therefore is to set the cellBarred IE included in the MIB to “barred.” The operator may receive unnecessary SIB1 requests. This can waste UE battery since the cell can't be used at the moment and therefore SIB1 acquisition cannot result in successful cell connectivity.

Accordingly, in implementations an operator that uses on-demand SIB1 transmission (e.g., does not regularly broadcast SIB1) can perform one or more of the following: use one of the custom PCIDs in the SSB for cell defining SSB transmission (CD-SSB) only; set the cellBarred IE included in the MIB to “barred”; and/or use the field ssb-SubcarrierOffset to indicate that the cell does not provide SIB1. This can be done by using a value higher than 23 for a parameter called k_{SSB} (or k_ssb) (defined in TS 38.213) for FR1 or a value higher than 11 for FR2. A specific value of k_{SSB} may be employed, e.g. 30 for FR1 and 14 for FR2. k_{SSB} may indicate the frequency domain offset between SSB and the overall resource block grid in number of subcarriers. If k_ssb requires a value higher than 15, it can be represented by the combination of a PBCH data field and ssb-subcarrierOffset. Upon determining the above conditions are true, a UE can an initiate on-demand SIB1 request.

An operator that broadcasts SIB1 regularly and uses custom PCIDs as normal PCIDs, can perform one or more of the following (a) and/or (b):
(a) Set the cellBarred IE included in the MIB to “barred” when the cell is to be barred but can use the field ssb-SubcarrierOffset to indicate that this cell provides (e.g., broadcasts) SIB1. On-demand SIB1 capable UE can determine that the cell provides SIB1 regularly (e.g., broadcasts SIB1) and refrain from requesting SIB1 on-demand but will not try to access the cell as it is considered barred. Non-on-demand SIB1 capable UEs may not try to access the cell as it is considered barred. Some specific feature UEs like reduced capabilities (REDCAP) UEs, network energy saving (NES) UEs, and/or non-terrestrial network (NTN) capable UEs with or without intention to access for NTN use may proceed with receiving SIB1 to determine if such cells are actually barred.
(b) Not use the custom PCID for non-cell defining SSB. For CD-SSB if the custom PCID is to be used, an operator may set the cellBarred IE included in the MIB to “notBarred” when the cell operates normally. In this case, the field ssb-SubcarrierOffset is used to indicate that this cell provides (e.g., broadcasts) SIB1 and a UE accordingly can determine a common ControlResourceSet (CORESET), a common search space, and necessary PDCCH parameters.

An operator that does not broadcast SIB1 regularly can perform one or more of the following (a) and/or (b):
(a) Use k_{SSB} value 30 (for FR1) or value 14 (for FR2) to indicate that SIB1 is provided on on-demand basis. Non-on-demand SIB1 capable UEs can determine that SIB1 is not being broadcasted. In this case, the field pdcch-ConfigSIB1 may indicate the frequency positions where the UE may (or may not) find a SS/PBCH with a CORESET and search space for SIB1 (see, e.g., TS 38.213 clause 13). On-demand SIB1 capable UEs can determine that SIB1 is to be requested either directly based on k_{SSB} value 30 (for FR1) or value 14 (for FR2) and/or in combination with custom PCID and/or cellBarred in MIB.
(b) Various combinations of the above may also be utilized.

In implementations, a UE can determine from SSB (e.g., from MIB and/or PBCH payload) from a cell whether the UE is allowed to transmit on-demand a SIB1 transmission request for the cell. Thus, an MIB and/or PBCH can include a bit and/or IE indicating whether ‘SIB1 transmission request’ is allowed or not. This indication can be provided, e.g., using a spare value available in MIB.

In implementations, non-on-demand SIB1 capable UEs can try to acquire SIB1 from a cell assuming normal and/or regular SIB1 broadcast and after attempting SIB1 acquisition for a threshold time and/or threshold number of attempts, can bar the cell for 300 seconds. To prevent such scenarios, a configurable timer value can be used to prevent UE's repeated SIB1 acquisition attempts. In an example the timer value can be signaled, for instance, using a combination of code points available from pdcch-ConfigSIB1 and k_{SSB}.

### BEGINNING OF NEW DISCLOSURE

In implementations, a trigger for on-demand SIB1 request/transmission includes a parameter configured for an on-demand SIB1 request. The parameter, for instance, represents specific K_{SSB} values. At least one example utilizes K_{SSB} values >11 (for FR2) or >23 (for FR1) and makes 4 (FR2) or 8 (FR1) code points available for on-demand SIB1 requests/transmissions. To receive required configuration, table(s) can be implemented using these code points and optionally in conjunction with a number of PCID and/or pdcch-ConfigSIB1 indices (e.g., controlResourceSetZero, searchSpaceZero) to provide the following information in Table 6.

TABLE 6

| | |
|---|---|
| a) | Frequency domain offset between SSB and the overall resource block grid in number of |
| | subcarriers, and |
| b) | A common search space and necessary PDCCH parameters |
| c) | the QCL relation between SS/PBCH blocks |
| d) | PRACH resources (e.g., some IEs from SI-Request-Config and random access channel RACH- |
| | ConfigGeneric) such as illustrated in the accompanying figures. |

FIG. 7 illustrates an example SI-Request-Config IE 700 in accordance with aspects of the present disclosure.

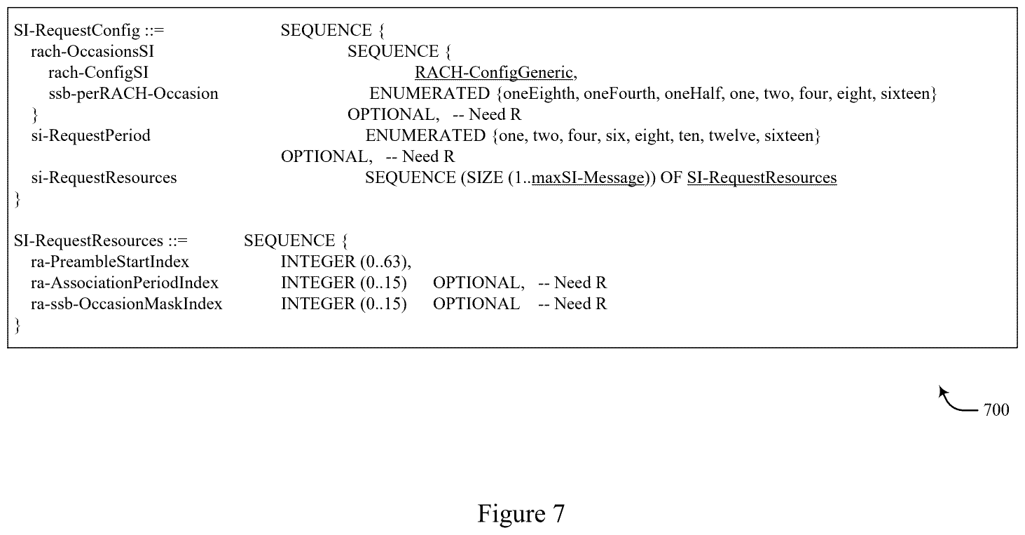

FIG. 8 illustrates an example RACH-ConfigGeneric IE 800 in accordance with aspects of the present disclosure.

In implementations and from the combination of code points (e.g., 8 for FR2) and from a number of custom PCIDs (e.g., 10), 80 indices can be made available and if the pdcch-ConfigSIB1 indices (controlResourceSetZero, searchSpaceZero) are used as well then many more are possible. Table 7 below presents some example correlations between index values and IE values in accordance with aspects of the present disclosure.

TABLE 7

| Index | IE-1 | IE-2 | IE-3 | IE-4 | . . . | IE-N |
|---|---|---|---|---|---|---|
| 1 | Value-1 | Value-1 | Value-11 | Value-31 | Value-1 | Value-1 |
| 2 | Value-1 | Value-2 | Value-55 | Value-61 | Value-1 | Value-16 |
| 3 | Value-1 | Value-1 | Value-1 | Value-10 | Value-4 | Value-21 |
| . . . | Value-2 | Value-2 | Value-2 | Value-2 | Value-6 | Value-28 |
| M | Value-3 | Value-4 | Value-3 | Value-3 | Value-10 | Value-35 |

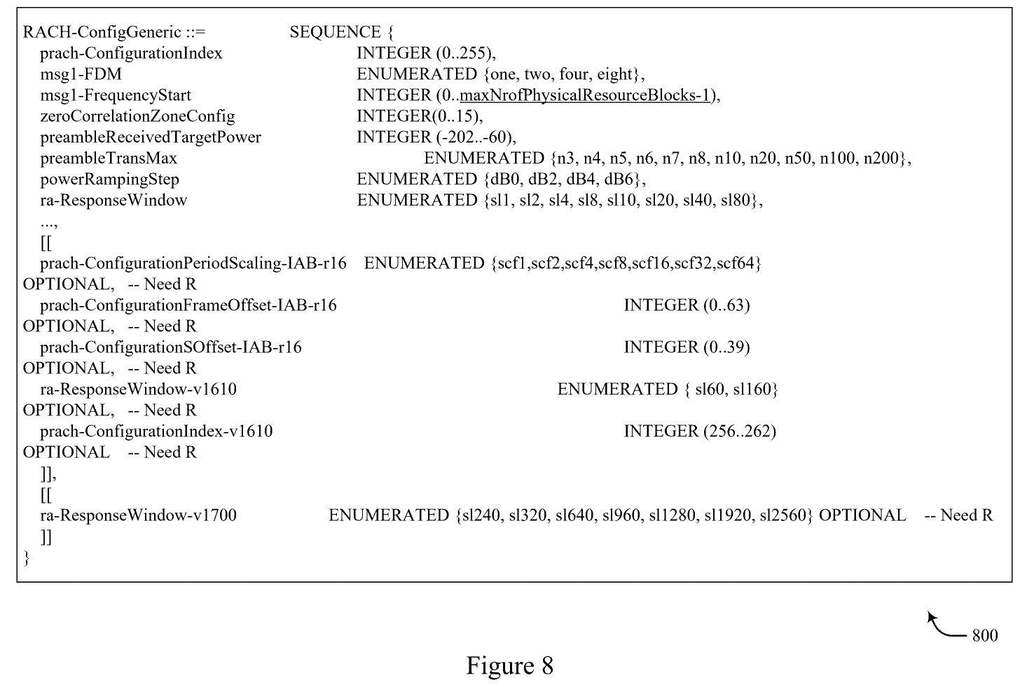

FIG. 9 illustrates an example IE 900 in accordance with aspects of the present disclosure. In implementations one or more of the parameters from Table 6 above can have default and/or specified values in one of the 3GPP specifications and these can be optional for the columns of Table 7, such as illustrated in the IE 900.

In implementations the K_{SSB} values >11 (for FR2) or >23 (for FR1) can be used even if some non-on-demand SIB1 capable UEs may need to receive broadcasted SIB1 but cannot. For instance, TS 38.213 specification indicates that if the UE detects the second SS/PBCH block and the second SS/PBCH block does not provide a CORESET for Type0-PDCCH CSS set, as described in clause 4.1, the UE may ignore the information related to Global Synchronization Channel Number (GSCN) of SS/PBCH block locations for performing cell search. Thus, some non-on-demand SIB1 capable UEs (e.g., NTN, REDCAP, NES UEs) can utilize excessive battery resources. To minimize this impact, an MIB barring bit can be used to mitigate non-on-demand SIB1 capable UEs from attempting to acquire SIB1. On-demand SIB1 capable UEs can determine to request SIB1 on-demand and the corresponding resources in view of the custom PCID presence in SSBs, cellBarred indication in MIB, and/or K_{SSB} values >11 (for FR2) or >23 (for FR1).

In at least one example, K_{SSB} is set as value ‘30’ to indicate that a SIB1 request (e.g., wake-up signal) is required to obtain SIB1. The PRACH resources for SIB1 requests can be specified by custom PCIDs (e.g., PCID #100 is PRACH_Config1; PCID #200 is PRACH_Config2, etc.) and/or from controlResourceSetZero and/or searchSpaceZero indices, such as discussed above.

According to implementations, k_{SSB} represents a first parameter that includes ssb-SubcarrierOffset where extended values are not utilized (e.g., where, k_{SSB}<24/or k_{SSB}<12 for FR2). When extended values are utilized (e.g., k_{SSB}>23/11), k_{SSB} can represent ssb-SubcarrierOffset+a PBCH field. Further, a second parameter can be pdcch-ConfigSIB1, which can include CORESET information and search space information, e.g., ControlResourceSetZero and SearchSpaceZero.

In at least one example, K_{SSB} is set as value ‘31’ and both controlResourceSetZero and/or searchSpaceZero indices to 0. Thus the GSCN range can be

$$[ {N}_{GSCN}^{Reference} , {N}_{GSCN}^{Reference} ] ,$$

and non-on-demand SIB1 capable UEs can determine that there is no information for a second SS/PBCH block with a CORESET for an associated Type0-PDCCH CSS set on the detected SS/PBCH block. Setting controlResourceSetZero and/or searchSpaceZero indices to ‘0’ can cause non-on-demand SIB1 capable UEs to not try to acquire SIB1 elsewhere. Custom PCIDs and/or cell barring can signal on-demand SIB1 capable UEs to communicate SIB1 requests. For instance, use of custom PCIDs and/or cell barring in MIB, on-demand SIB1 capable UEs can determine that a SIB1 request is required and can determine the PRACH and other resources/configurations, e.g., as discussed above.

Implementations include ways to receive and/or deliver SIB1. Determinations of whether to make SIB1 requests, which resources to use for making SIB1 requests, which resources for receiving acknowledgement can be based on implementations described throughout this disclosure. For instance, after communicating (e.g., transmitting, delivering, propagating, etc.) a SIB1 request a UE can attempt to receive broadcasted SIB1 with the assumption that SIB1 is being regularly broadcasted. A SIB1 acquisition attempt can be initiated immediately after communicating a SIB1 request and/or after a time duration (e.g., after T₀ milliseconds, S₀ slots, SF₀ subframes, F₀ frames, etc.) after communicating the SIB1 request. Default subcarrier spacing can be used to calculate timing based on the slots and/or subframes. When a UE attempting to acquire broadcasted SIB1 UE attempts for a time duration (e.g., after T₁ milliseconds, S₁ slots, SF₁ subframes, F₁ frames, etc.) to receive SIB1, the UE may retransmit a SIB1 request.

In implementations, a UE can communicate ‘x’ repetitions of SIB1 requests before the UE starts timer TO and attempts receiving SIB1 broadcast. The parameters ‘x’, To milliseconds, S₀ slots, SF₀ subframes, F₀ frames, T₁ milliseconds, S₁ slots, SF₁ subframes, F₁ frames, etc. can have specified values and/or can be included in columns of Table 7, above. In implementations, a UE can attempt to receive an Ack (e.g., Msg2) before it starts timer T₀ and attempts to receive (e.g., acquire, obtain, etc.) SIB1 broadcast.

### END OF NEW DISCLOSURE, BEGINNING OF PREVIOUS RELATED DISCLOSURE FOR RESOURCES

Implementations described in the present disclosure also provide for determining resources (e.g., radio resources) for transmitting on-demand SIB1 requests. In the following, the terminology PRACH resource should be understood to include a variety of different resources including time resources, frequency resources, preamble IDs of a PRACH transmission, etc.

In implementations, a UE transmits a “first signal” for an on-demand SIB1 request. A UE, for instance, can determine a PRACH resource of the first signal in relation to the resource where the UE detects an SSB transmission.

In implementations, the UE determines a frequency resource for the first signal based on a resource where the UE has received an SSB transmission. An SSB, for instance, is characterized by a NE transmitting one or more of the following elements (see background section for detailed description of SSB and its contents): Synchronization signal(s), such as PSS and/or SSS; PBCH, which may include a MIB for a cell; and DM-RS.

In at least one example, the frequency resource for the first signal can be determined with respect to a frequency reference point (e.g., “Point F”). Point F can in an example be the lowest subcarrier where the SSB and/or one of its components (e.g. PBCH, PSS, and/or SSS) is detected. See, for example, “Time and Frequency Structure of an SS/PBCH block” discussed above, where Point F may be equivalent to subcarrier number 0 of the SSB (see also FIG. 2).

In implementations, transmissions of the first signal are to be aligned with a resource block grid, where in frequency domain a resource block consists of a plurality of subcarriers. In at least one example, a UE may assume that Point F coincides with the resource block grid. For example the UE may assume that the lowest subcarrier for the transmission of the first signal is the same subcarrier as identified by Point A. Point A is a logical point in frequency, such that the locations of different bandwidth parts (BWPs) are determined with a non-negative offset relative to the Point A. The BWP concept allows for the network to configure different UEs with different operating bandwidth within the overall carrier bandwidth. From a cell's perspective there is a common resource block (CRB) grid relative to a common point in frequency called Point A. Specifically, Point A is the frequency location of the first subcarrier of the common resource block CRB0 for all subcarrier spacings.

In implementations the SSB transmission (e.g., Point F) may not be aligned with the resource block grid. In such implementations a subcarrier offset may be used between Point F and the resource block grid. Accordingly, the subcarrier offset may be implemented in various ways. For instance, the subcarrier offset may be a fixed value. Alternatively or additionally, the subcarrier offset can be indicated by and/or determined from information contained in the SSB, e.g. in the MIB.

According to at least one implementation, the subcarrier offset can be determined according to the following procedure: The subcarrier offset is determined from value k_{SSB} (see TS 38.213), where e.g. 24≤K_{SSB}≤31 (or a subset of these values) for FR1 or for 12≤k_{SSB}≤15 (or a subset of these values) for FR2. Different k_{SSB} values from the corresponding range may be associated with different subcarrier offsets. In an example in FR1 the subcarrier offset (in unit of subcarriers) can be determined as 2·(K_{SSB}−24) in FR1 or as 3·(K_{SSB}−12) in FR2. In another example the subcarrier offset can be determined based on look-up tables for FR1 and FR2. For instance, Table 6 below presents example subcarrier offset values for FR1 and Table 7 below presents example subcarrier offset values for FR2.

TABLE 6

| | subcarrier |
|---|---|
| | offset |
| k_{SSB} | [subcarriers] |
| 24 | 0 |
| 25 | 1 |
| 26 | 4 |
| 27 | 5 |
| 28 | 8 |
| 29 | 9 |
| 30 | N/A |
| 31 | N/A |

TABLE 7

| | subcarrier |
|---|---|
| | offset |
| k_{SSB} | [subcarriers] |
| 12 | 0 |
| 13 | 1 |
| 14 | 8 |
| 15 | 9 |

According to NR Release 18, values 24≤K_{SSB}≤29 and K_{SSB}=31 in FR1 and values 12≤K_{SSB}≤13 and k_{SSB}=15 in FR2 are already used for a different purpose. Therefore K_{SSB}=30 in FR1 and K_{SSB}=14 in FR2 can be used for the purpose of indicating a subcarrier offset. These two values can indicate that one or more of the bits or fields included in MIB are used to determine the subcarrier offset. According to implementations, one or more of controlResourceSetZero and searchSpaceZero (contained in pdcch-ConfigSIB1) determine the subcarrier offset if K_{SSB}=30 in FR1 or K_{SSB}=14 in FR2. In such cases, the original controlResourceSetZero and searchSpaceZero may be assumed to have a fixed or preconfigured value, e.g. a default value.

According to implementations, a UE may determine two different k_{SSB} values in two different time instances of PBCH reception. If both of these time instances are no further apart than a specific time duration, the UE may interpret this such that the cell provides both periodic SIB1 transmissions (e.g., SIB1 broadcast) according to the reception of a first PBCH (including the first value of k_{SSB}) and the opportunity for the UE to request SIB1 transmissions according to the reception of a second PBCH (including the second value of k_{SSB}). According to implementations, the specific time duration is an integer fraction of the basic periodicity interval of PBCH transmissions. The basic periodicity interval of PBCH transmissions may be an interval during which a UE may assume that the MIB contained in the PBCH is static, e.g., doesn't change. For example, if the basic periodicity interval of PBCH transmissions is 160 ms, then the specific time duration may be one of {1; 2; 4; 5; 8; 10; 16; 20; 32; 40; 80; 160} ms.

In implementations a UE determines the resource (e.g., PRACH resource) for the first signal based on an indication detected in an SSB transmission. In at least one example, the UE determines the PRACH resource based on a detected PCID. The PCID, for instance, may be determined from a combination of detected PSS and SSS sequences, e.g.,

$$PCID = 3 \cdot {N}_{ID}^{( 1 )} + {N}_{ID}^{( 2 )} ,$$

where

$${N}_{ID}^{( 1 )}$$

is a value within [0; 333] and

$${N}_{ID}^{( 2 )}$$

corresponds to the PSS index, e.g., a value from {0; 1; 2}.

In at least one example, the UE determines a first PRACH occasion (e.g., in frequency domain) if the PCID is an even number, and second PRACH occasion (e.g., in frequency domain) if the PCID is an odd number. In at least one example, the UE determines a first PRACH occasion in frequency domain for a first detected PSS index value (e.g. for

$${N}_{ID}^{( 2 )} = 0 ) ,$$

a second PRACH occasion in frequency domain for a second detected PSS index value (e.g. for

$${N}_{ID}^{( 2 )} = 1 ) ,$$

and a third PRACH occasion in frequency domain for a third detected PSS index value (e.g. for

$${N}_{ID}^{( 2 )} = 2 ) .$$

In at least one example, the UE determines the PRACH occasion in frequency domain as PCID modulo k̅. For details of determining k̅ refer to TS 38.211 v 19.0.0, e.g., clause 6.3.3.2 and Table 6.3.3.2-1.

In at least one example, the MIB and/or PBCH includes information indicating resources for the first signal transmission. For instance, one value of the information indicates that a UE is not to transmit a first signal, e.g., is not to transmit a request for SIB1 transmission. In at least one example, a preamble index (also known as Random Access Preamble ID) is associated with a PCID. Transmitting the associated preamble can imply a request for the SIB1 transmission for the PCID to which the preamble is associated.

In implementations, a UE determines a PRACH configuration index as a function of information contained in MIB or PBCH, e.g., as a function of the PCID. In 5G NR, tables defining the PRACH configuration index are given by Tables 6.3.3.2-2 to 6.3.3.2-4 in TS 38.211 v 19.1.0.

According to at least one implementation, the UE determines a PRACH configuration index for transmission of a request for SIB1 transmission from a subset of the set of PRACH configuration indices.

In at least one example, the subset is formed by PRACH configuration indices that share the same preamble format, e.g. preamble format 0.

In at least one example, the subset is formed by PRACH configuration indices that share the same number of subframes. For example according to Table 6.3.3.2-2, PRACH configuration indices {0-18, 28-46, 53-77, 88, 90, 93, 95-98, 101-102, 109-110, 113-114, 118, 120, 122, 124-127, 130-131, 138-139, 142-143, 148, 150, 152, 154-157, 160-161, 168-169, 172-173, 178, 180, 183, 185-188, 191-192, 199, 201, 203, 206-211, 219, 221, 223-226, 229-230, 237, 239, 241, 243-246, 249-250} have only one subframe defined, and these configuration indices can form the subset.

In at least one example, the subset is formed by PRACH configuration indices that share the same subframe number(s). For example according to Table 6.3.3.2-2, PRACH configuration indices {87, 89, 91-92, 94, 100, 108, 112, 129, 141, 147, 149, 151, 159, 171, 177, 179, 181-182, 184, 190, 198, 200, 202, 204-205, 214, 220, 222, 228, 236, 238, 240, 248} have subframes 4 and 9 defined, and these configuration indices can form the subset.

In at least one example, the subset is formed by PRACH configuration indices that share the same starting symbol. For example according to Table 6.3.3.2-4, PRACH configuration indices {41, 43-44, 48, 50, 52, 54-55, 58} have starting symbol 5 defined, and these configuration indices can form the subset.

In at least one example, the subset is formed by PRACH configuration indices that share the same number of PRACH slots within a subframe. For example according to Table 6.3.3.2-3, PRACH configuration indices {0-66, 256-262} have no number of PRACH slots within a subframe defined, and these configuration indices can form the subset.

In at least one example, the subset is formed by PRACH configuration indices that share the same number of time-domain PRACH occasions within a PRACH slot. For example according to Table 6.3.3.2-3, PRACH configuration indices {0-66, 256-262} have no number of time-domain PRACH occasions within a PRACH slot defined, and these configuration indices can form the subset.

In at least one example, the subset is formed by PRACH configuration indices that share the same PRACH duration. For example according to Table 6.3.3.2-3, PRACH configuration indices {145-168} have a PRACH duration of 12 defined, and these configuration indices can form the subset.

According to implementations described herein, the first signal is one or more of a RACH preamble, physical uplink control channel (PUCCH) (e.g., a scheduling request), or a wake-up signal. In at least one example, the MIB includes information specifying whether the UE is to determine the resources for the first signal according to one or more of the implementations described herein.

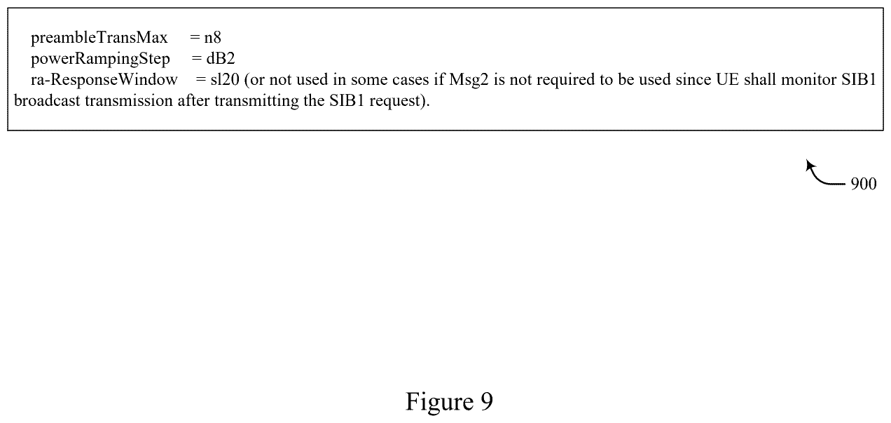

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein.

The UE 1000 may be configured to or operable to support a means for receiving SSB; and transmitting a SIB1 request based at least in part on the SSB including one or more of a cell identifier configured for on-demand SIB1 transmission, a first parameter configured for on-demand SIB1 request, or a second parameter configured for on-demand SIB1 request.

Additionally, the UE 1000 may be configured to support any one or combination of where the cell identifier includes a PCID; the first parameter includes a frequency domain offset between the SSB and a resource block grid in numbers of subcarriers, and further including determining, if a value for the first parameter is greater than a specified value, that the first parameter is to be determined via a PBCH field; the second parameter includes PDCCH configuration for receiving SIB1, and the second parameter includes common CORESET information, a common search space, and one or more PDCCH parameters; the first parameter includes at least one of: one or more first parameter values for a first frequency range; or one or more second parameter values for a second frequency range; the SSB further includes an indication of one or more PRACH resources for transmission of for the SIB1 request, and further including transmitting the SIB1 request on at least one PRACH resource of the one or more PRACH resources; further including: determining at least one index value using a combination of the cell identifier, the first parameter, and the second parameter; and determining the at least one resource based at least in part on the index value.

Additionally, the UE 1000 may be configured to support any one or combination of means for attempting, after transmission of the SIB request, to receive broadcasted SIB1; further including one or more of: attempting to receive the broadcasted SIB1 immediately after transmission of the SIB1 request; or attempting to receive the broadcasted SIB1 after a first time duration after transmission of the SIB1 request; further including retransmitting the SIB1 request based at least in part on not receiving SIB1 after a second time duration; the SSB includes a MIB, and further including determining that the MIB includes an indication that cell access is barred; and transmitting the SIB1 request based at least in part on the cell identifier configured for on-demand SIB1 transmission, the first parameter configured for on-demand SIB1 request, the second parameter configured for on-demand SIB1 request, and the MIB indicating that cell access is barred; further including receiving SIB1, the SIB1 including RMSI.

Additionally, or alternatively, the UE 1000 may support at least one memory (e.g., the memory 1004) and at least one processor (e.g., the processor 1002) coupled with the at least one memory and configured to cause the UE to receive SSB; and transmit a SIB1 request based at least in part on the SSB including one or more of a cell identifier configured for on-demand SIB1 transmission, a first parameter configured for on-demand SIB1 request, or a second parameter configured for on-demand SIB1 request.

Additionally, the UE 1000 may be configured to support any one or combination of where the cell identifier includes a PCID; the first parameter includes a frequency domain offset between the SSB and a resource block grid in numbers of subcarriers, and the at least one processor is configured to cause the UE to determine, if a value for the first parameter is greater than a specified value, that the first parameter is to be determined via a PBCH field; the second parameter includes PDCCH configuration for receiving SIB1, and the second parameter includes common CORESET information, a common search space, and one or more PDCCH parameters; the first parameter includes at least one of: one or more first parameter values for a first frequency range; or one or more second parameter values for a second frequency range; the SSB further includes an indication of one or more PRACH resources for transmission of for the SIB1 request, and the at least one processor is configured to cause the UE to transmit the SIB1 request on at least one PRACH resource of the one or more PRACH resources; the at least one processor is configured to cause the UE to: determine at least one index value using a combination of the cell identifier, the first parameter, and the second parameter; and determine the at least one resource based at least in part on the index value.

Additionally, the UE 1000 may be configured to support any one or combination of where the at least one processor is configured to cause the UE to attempt, after transmission of the SIB request, to receive broadcasted SIB1; the at least one processor is configured to cause the UE to one or more of: attempt to receive the broadcasted SIB1 immediately after transmission of the SIB1 request; or attempt to receive the broadcasted SIB1 after a first time duration after transmission of the SIB1 request; the at least one processor is configured to cause the UE to retransmit the SIB1 request based at least in part on not receiving SIB1 after a second time duration; the SSB includes a MIB, and the at least one processor is configured to cause the UE to: determine that the MIB includes an indication that cell access is barred; and transmit the SIB1 request based at least in part on the cell identifier configured for on-demand SIB1 transmission, the first parameter configured for on-demand SIB1 request, the second parameter configured for on-demand SIB1 request, and the MIB indicating that cell access is barred; the at least one processor is configured to cause the UE to receive SIB1, the SIB1 including RMSI.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

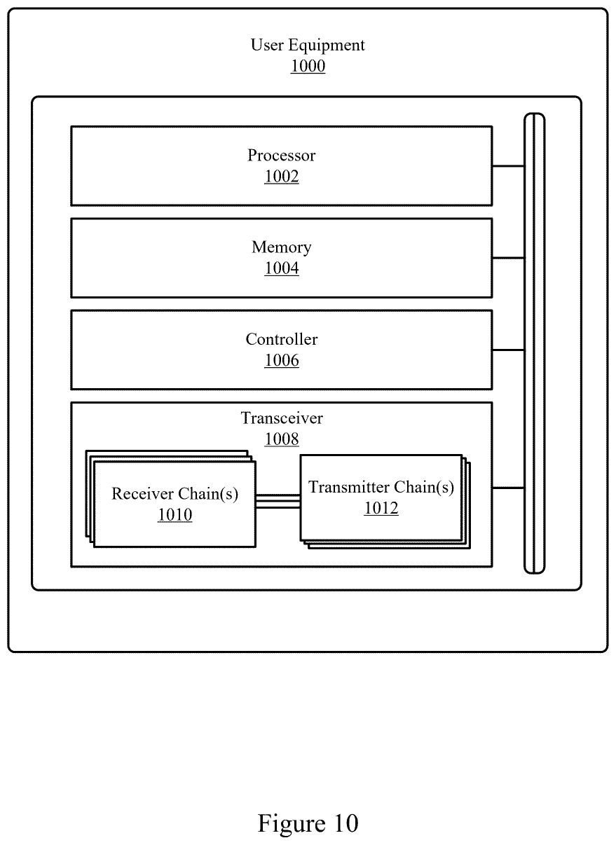

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to receive SSB; and transmit a SIB1 request based at least in part on the SSB including one or more of a cell identifier configured for on-demand SIB1 transmission, a first parameter configured for on-demand SIB1 request, or a second parameter configured for on-demand SIB1 request.

Additionally, the processor 1100 may be configured to or operable to support any one or combination of where the first parameter includes a frequency domain offset between the SSB and a resource block grid in numbers of subcarriers, and wherein the at least one controller is configured to cause the processor to determine, if a value for the first parameter is greater than a specified value, that the first parameter is to be determined via a PBCH field; the second parameter includes PDCCH configuration for receiving SIB1, and the second parameter includes common CORESET information, a common search space, and one or more PDCCH parameters; the at least one controller is configured to cause the processor to one or more of: attempt to receive broadcasted SIB1 immediately after transmission of the SIB1 request; or attempt to receive the broadcasted SIB1 after a first time duration after transmission of the SIB1 request.

Additionally, the processor 1100 may be configured to or operable to support any one or combination of where the cell identifier includes a PCID; the first parameter includes a frequency domain offset between the SSB and a resource block grid in numbers of subcarriers, and at least one controller is configured to cause the processor to determine, if a value for the first parameter is greater than a specified value, that the first parameter is to be determined via a PBCH field; the second parameter includes PDCCH configuration for receiving SIB1, and the second parameter includes common CORESET information, a common search space, and one or more PDCCH parameters; the first parameter includes at least one of: one or more first parameter values for a first frequency range; or one or more second parameter values for a second frequency range; the SSB further includes an indication of one or more PRACH resources for transmission of for the SIB1 request, and at least one controller is configured to cause the processor to transmit the SIB1 request on at least one PRACH resource of the one or more PRACH resources; the at least one processor is configured to cause the UE to: determine at least one index value using a combination of the cell identifier, the first parameter, and the second parameter; and determine the at least one resource based at least in part on the index value.

Additionally, the processor 1100 may be configured to or operable to support any one or combination of where the at least one controller is configured to cause the processor to attempt, after transmission of the SIB request, to receive broadcasted SIB1; the at least one processor is configured to cause the UE to one or more of: attempt to receive the broadcasted SIB1 immediately after transmission of the SIB1 request; or attempt to receive the broadcasted SIB1 after a first time duration after transmission of the SIB1 request; the at least one controller is configured to cause the processor to retransmit the SIB1 request based at least in part on not receiving SIB1 after a second time duration; the SSB includes a master information block (MIB), and wherein the at least one processor is configured to cause the UE to: determine that the MIB includes an indication that cell access is barred; and transmit the SIB1 request based at least in part on the cell identifier configured for on-demand SIB1 transmission, the first parameter configured for on-demand SIB1 request, the second parameter configured for on-demand SIB1 request, and the MIB indicating that cell access is barred; the at least one controller is configured to cause the processor to receive SIB1, the SIB1 including RMSI.

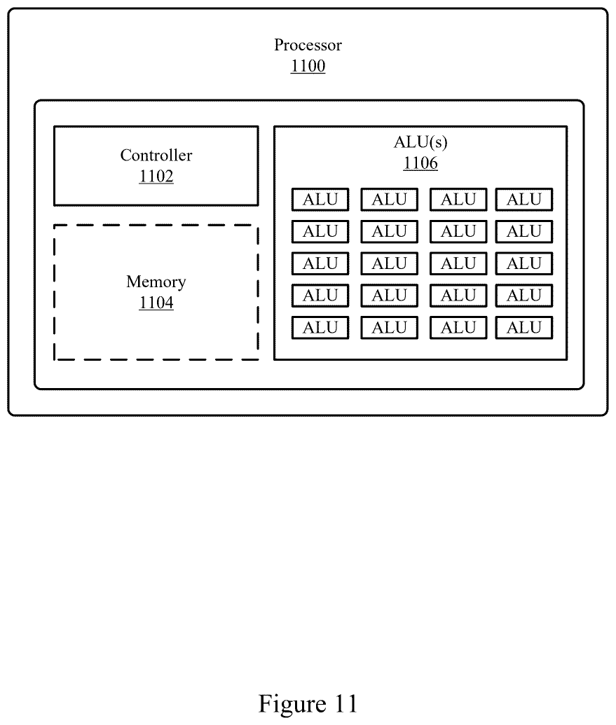

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein.

The NE 1200 may be configured to or operable to support a means for transmitting SSB including one or more of a cell identifier configured for on-demand SIB1 transmission, a first parameter configured for on-demand SIB1 request, or a second parameter configured for on-demand SIB1 request; receiving a SIB1 request; and transmitting SIB1 based at least in part on the SIB1 request.

Additionally, the NE 1200 may be configured to or operable to support any one or combination of where the cell identifier includes a PCID, the first parameter includes a frequency domain offset between the SSB and a resource block grid in numbers of subcarriers, and the second parameter includes PDCCH configuration for receiving SIB1, and the second parameter includes common CORESET information, a common search space, and one or more PDCCH parameters; further including transmitting an indication of one or more resources for transmission of the SIB1 request, the indication including at least one index value generated using a combination of the cell identifier, the first parameter, and the second parameter.

Additionally, or alternatively, the NE 1200 may support at least one memory (e.g., the memory 1204) and at least one processor (e.g., the processor 1202) coupled with the at least one memory and configured to cause the NE to transmit SSB including one or more of a cell identifier configured for on-demand SIB1 transmission, a first parameter configured for on-demand SIB1 request, or a second parameter configured for on-demand SIB1 request; receive a SIB1 request; and transmit SIB1 based at least in part on the SIB1 request.

Additionally, the NE 1200 may be configured to support any one or combination of where the cell identifier includes a physical cell identifier (PCID), the first parameter includes a frequency domain offset between the SSB and a resource block grid in numbers of subcarriers, and the second parameter includes physical downlink control channel (PDCCH) configuration for receiving SIB1, and the second parameter including common CORESET information, a common search space, and one or more PDCCH parameters; the at least one processor is configured to cause the NE to transmit an indication of one or more resources for transmission of the SIB1 request, the indication including at least one index value generated using a combination of the cell identifier, the first parameter, and the second parameter.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

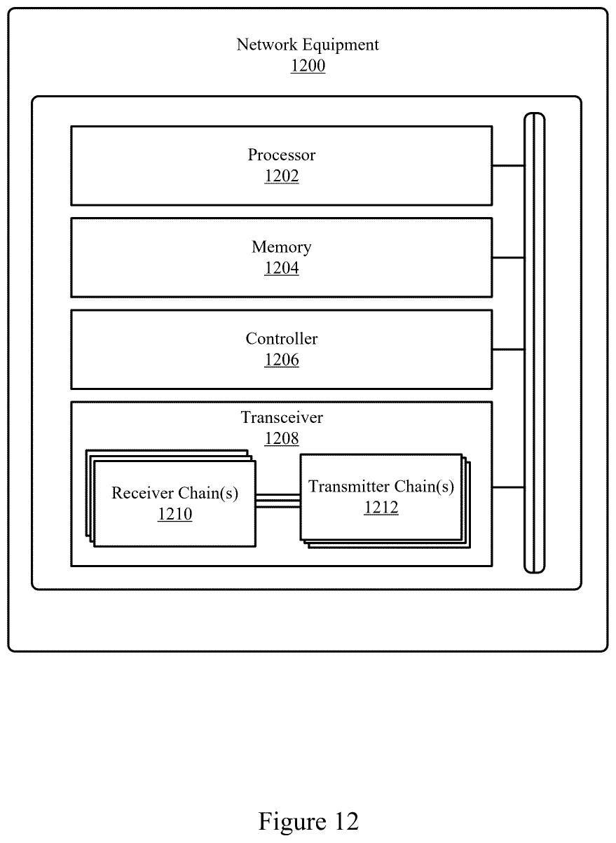

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving SSB. The operations of 1302 may be performed in accordance with examples as described herein. In some implementations, aspects of the operations of 1302 may be performed by a UE as described with reference to FIG. 10.

At 1304, the method may include transmitting a SIB1 request based at least in part on the SSB comprising one or more of a cell identifier configured for on-demand SIB1 transmission, a first parameter configured for on-demand SIB1 request, or a second parameter configured for on-demand SIB1 request. The operations of 1304 may be performed in accordance with examples as described herein. In some implementations, aspects of the operations of 1304 may be performed by a UE as described with reference to FIG. 10.

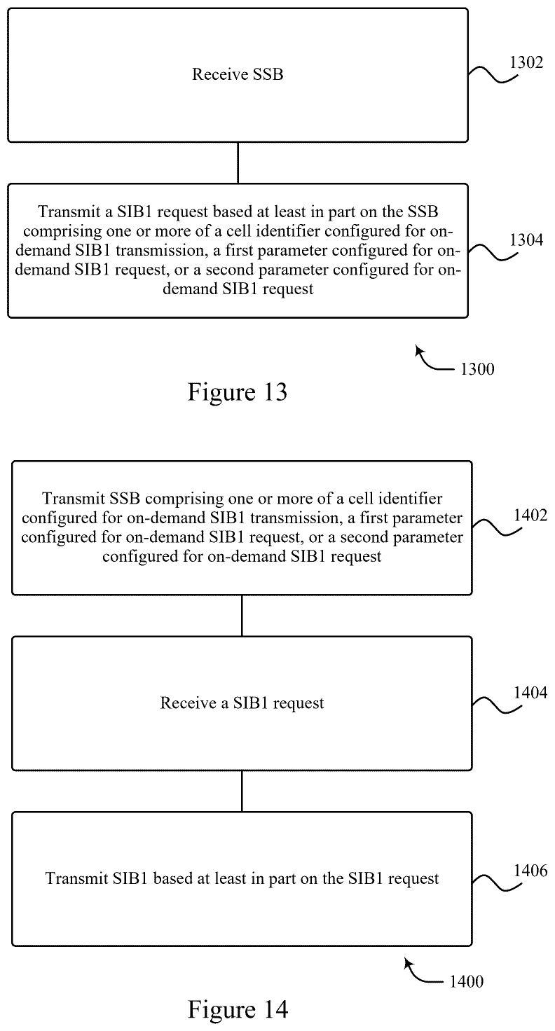

FIG. 14 illustrates a flowchart of a method 1400 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting SSB comprising one or more of a cell identifier configured for on-demand SIB1 transmission, a first parameter configured for on-demand SIB1 request, or a second parameter configured for on-demand SIB1 request. The operations of 1402 may be performed in accordance with examples as described herein. In some implementations, aspects of the operations of 1402 may be performed by a NE as described with reference to FIG. 12.

At 1404, the method may include receiving a SIB1 request. The operations of 1404 may be performed in accordance with examples as described herein. In some implementations, aspects of the operations of 1404 may be performed by a UE as described with reference to FIG. 12.

At 1406, the method may include transmitting SIB1 based at least in part on the SIB1 request. The operations of 1406 may be performed in accordance with examples as described herein. In some implementations, aspects of the operations of 1406 may be performed by a UE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive synchronization signal block (SSB); and
transmit a system information block 1 (SIB1) request based at least in part on the SSB comprising one or more of a cell identifier configured for on-demand SIB1 transmission, a first parameter configured for on-demand SIB1 request, or a second parameter configured for on-demand SIB1 request.

2. The UE of claim 1, wherein the cell identifier comprises a physical cell identifier (PCID).

3. The UE of claim 1, wherein the first parameter comprises a frequency domain offset between the SSB and a resource block grid in numbers of subcarriers, and wherein the at least one processor is configured to cause the UE to determine, if a value for the first parameter is greater than a specified value, that the first parameter is to be determined via a physical broadcast channel (PBCH) field.

4. The UE of claim 1, wherein the second parameter comprises physical downlink control channel (PDCCH) configuration for receiving SIB1, and the second parameter comprises common Control Resource Set (CORESET) information, a common search space, and one or more PDCCH parameters.

5. The UE of claim 1, wherein the first parameter comprises at least one of:
one or more first parameter values for a first frequency range; or
one or more second parameter values for a second frequency range.

6. The UE of claim 1, wherein the SSB further comprises an indication of one or more physical random access channel (PRACH) resources for transmission of for the SIB1 request, and wherein the at least one processor is configured to cause the UE to transmit the SIB1 request on at least one PRACH resource of the one or more PRACH resources.

7. The UE of claim 6, wherein the at least one processor is configured to cause the UE to:
determine at least one index value using a combination of the cell identifier, the first parameter, and the second parameter; and
determine the at least one resource based at least in part on the index value.

8. The UE of claim 1, wherein the at least one processor is configured to cause the UE to attempt, after transmission of the SIB request, to receive broadcasted SIB1.

9. The UE of claim 8, wherein the at least one processor is configured to cause the UE to one or more of:
attempt to receive the broadcasted SIB1 immediately after transmission of the SIB1 request; or
attempt to receive the broadcasted SIB1 after a first time duration after transmission of the SIB1 request.

10. The UE of claim 9, wherein the at least one processor is configured to cause the UE to retransmit the SIB1 request based at least in part on not receiving SIB1 after a second time duration.

11. The UE of claim 1, wherein the SSB comprises a master information block (MIB), and wherein the at least one processor is configured to cause the UE to:
determine that the MIB comprises an indication that cell access is barred; and
transmit the SIB1 request based at least in part on the cell identifier configured for on-demand SIB1 transmission, the first parameter configured for on-demand SIB1 request, the second parameter configured for on-demand SIB1 request, and the MIB indicating that cell access is barred.

12. The UE of claim 1, wherein the at least one processor is configured to cause the UE to receive SIB1, the SIB1 comprising remaining minimum system information (RMSI).

13. A network equipment for wireless communication, comprising:
at least one memory; and
at least one processor coupled with the at least one memory and configured to cause the network equipment to:
transmit synchronization signal block (SSB) comprising one or more of a cell identifier configured for on-demand SIB1 transmission, a first parameter configured for on-demand SIB1 request, or a second parameter configured for on-demand SIB1 request;
receive a SIB1 request; and
transmit SIB1 based at least in part on the SIB1 request.

14. The network equipment of claim 13, wherein the cell identifier comprises a physical cell identifier (PCID), the first parameter comprises a frequency domain offset between the SSB and a resource block grid in numbers of subcarriers, and the second parameter comprises physical downlink control channel (PDCCH) configuration for receiving SIB1, and the second parameter comprising common Control Resource Set (CORESET) information, a common search space, and one or more PDCCH parameters.

15. The network equipment of claim 13, wherein the at least one processor is configured to cause the network equipment to transmit an indication of one or more resources for transmission of the SIB1 request, the indication comprising at least one index value generated using a combination of the cell identifier, the first parameter, and the second parameter.

16. A processor for wireless communication, comprising:
at least one controller coupled with at least one memory and configured to cause the processor to:
receive synchronization signal block (SSB); and
transmit a system information block 1 (SIB1) request based at least in part on the SSB comprising one or more of a cell identifier configured for on-demand SIB1 transmission, a first parameter configured for on-demand SIB1 request, or a second parameter configured for on-demand SIB1 request.

17. The processor of claim 16, wherein the first parameter comprises a frequency domain offset between the SSB and a resource block grid in numbers of subcarriers, and wherein the at least one controller is configured to cause the processor to determine, if a value for the first parameter is greater than a specified value, that the first parameter is to be determined via a physical broadcast channel (PBCH) field.

18. The processor of claim 16, wherein the second parameter comprises physical downlink control channel (PDCCH) configuration for receiving SIB1, and the second parameter comprises common Control Resource Set (CORESET) information, a common search space, and one or more PDCCH parameters.

19. The processor of claim 16, wherein the at least one controller is configured to cause the processor to one or more of:
attempt to receive broadcasted SIB1 immediately after transmission of the SIB1 request; or
attempt to receive the broadcasted SIB1 after a first time duration after transmission of the SIB1 request.

20. A method performed by a user equipment (UE), the method comprising:
receiving synchronization signal block (SSB); and
transmitting a system information block 1 (SIB1) request based at least in part on the SSB comprising one or more of a cell identifier configured for on-demand SIB1 transmission, a first parameter configured for on-demand SIB1 request, or a second parameter configured for on-demand SIB1 request.
